(19) United States
(12) Patent Application Publication
(10) Pub. No.: US 2026/0269873 A1
(43) Pub. Date: Sep. 10, 2026

(54) WIRELESS TELECOMMUNICATIONS NETWORK

(71) Applicant: British Telecommunications Public Limited Company, London (GB)

(72) Inventors: Linglong DAI, Beijing (CN); Yuhao CHEN, Beijing (CN); Jianjun LI, Beijing (CN); Jingbo TAN, Beijing (CN); Mo HAO, Beijing (CN); Richard MACKENZIE, Colchester (GB)

(21) Appl. No.: 18/881,517

(22) PCT Filed: Jun. 8, 2023
(86) PCT No.: PCT/EP2023/065333

§ 371 Date: Jan. 6, 2025

(30) Foreign Application Priority Data
Jul. 8, 2022 (WO) PCT/CN2022/104529

(51) Int. Cl. H04B 7/04; H04B 7/06

(52) U.S. Cl. CPC H04B 7/04013; H04B 7/0617

(57) ABSTRACT

This invention provides a network node for configuring a Reconfigurable Intelligent Surface, RIS, in a wireless telecommunications network, the wireless telecommunications network comprising a transmitting node and a receiving node, the network node comprising a configuration module configured to: configure the RIS according to a beam training codebook so as to define a training beam pair; obtain data indicative of a direction between the RIS and the receiving node, the direction between the RIS and receiving node derivable from the powers of each beam of the training beam pair at the receiving node; and configure the RIS according to a data transmission codebook, the data transmission codebook defining a data transmission beam in the direction between the RIS and the receiving node. This invention also provides a receiving node in a wireless telecommunications network, the wireless telecommunications network comprising a transmitting node and a Reconfigurable Intelligent Surface, RIS, the receiving node comprising: a receiver configured to receive a training beam pair transmitted by the transmitting node and reflected by the RIS; a measurement module configured to determine the power of each training beam of the training beam pair at the receiving node; and a processor configured to determine a direction between the RIS and the receiving node based on the powers of each beam of the training beam pair at the receiving node.

### FIELD OF THE INVENTION

The present invention relates to a wireless telecommunications network comprising a Reconfigurable Intelligent Surface (RIS).

### BACKGROUND

In wireless telecommunications, a wireless signal being transmitted between a transmitter and receiver generally degrades due to interference from other wireless signals and/or other physical phenomena (e.g. fading and blockage). This has generally been addressed by improving the transmission characteristics (e.g. higher power transmissions or repeaters) or transmission processing techniques (e.g. more robust modulation schemes). An emerging concept in wireless telecommunications is the concept of a reconfigurable propagation environment, or “smart radio environment”, which may improve the transmission quality. This may be achieved by use of a surface of electromagnetic material, often known as a Reconfigurable Intelligent Surface (RIS), which may be operated to apply a change to an incident wireless signal, such as a change in phase, amplitude, frequency and polarisation, so as to improve the transmission quality between the transmitter and the receiver.

In a conventional system having only a transmitter and receiver, the receiver may receive a wireless signal in a direct path between the transmitter and receiver or via one or more reflected signals. In a first scenario, the receiver may not be able to successfully receive either of the direct or reflected signals from the transmitter (that is, the receiver is in a “not-spot”). In a second scenario, a reflected signal between the transmitter and receiver (e.g. reflected off a nearby building) degrades another received signal (e.g. the direct signal) by destructive interference. Both of these scenarios can be improved by the introduction of an RIS. In the first scenario where the receiver cannot receive either the direct or reflected signals from the transmitter, the RIS may act upon the reflected signal so that it may be successfully received at the receiver. Furthermore, in the second scenario, the RIS may phase shift the incident wireless signal so that it constructively interferes with the direct signal between the transmitter and receiver. The RIS may therefore be used to improve transmission quality between the transmitter and the receiver.

Furthermore, a RIS may be a cost-effective solution to improving transmission quality compared to alternative solutions, such as by increasing access point density, as RISs are nearly passive and easy to deploy. Alternative names for the RIS include intelligent reflective surface, large intelligent surface, large intelligent metasurface, programmable metasurface, reconfigurable metasurface, smart reflect-arrays, software-defined surface, and passive intelligent surface. The term “reconfigurable” is often used to indicate that the angle of reflection can be configured regardless of the angle of incidence.

Future wireless telecommunications networks may utilise relatively high frequencies (e.g. >6 GHz) in communications between the transmitter and receiver. These high frequency communications suffer from high path loss in free space and poor attenuation through materials. To address these issues, high-frequency communications are typically transmitted in narrow beams to the user through a process of beamforming. In RIS-assisted communications utilising beamforming techniques, the RIS generates a plurality of beams in which each beam is transmitted in a different direction and a process of “beam training” is used to determine the best beam for a particular user. This typically involves the transmission of the plurality of beams to a space within which the user resides and determining, from user measurements, the beam supporting the best communications channel. An example of this method is detailed in “Construction of a generalized DFT codebook using channel-adaptive parameters,” IEEE Commun. Lett., vol. 21, no. 1, pp. 196-199, January 2017., J. Suh et al.

“Fast beam training and alignment for IRS-assisted millimeter wave/terahertz systems,” IEEE Trans. Wireless Commun., pp. 1-1, April 2021, P. Wang et al., proposed a multi-directional beams-based beam-training framework, which exploited the inherent sparse structure of the channel between the transmitter, RIS and receiver. By randomly generating a sensing matrix and carrying out a few rounds of full coverage scanning, the best direction lied in the intersection of the generated multi-directional beams. Since multiple directional beams are generated simultaneously, the overhead of full-coverage scanning is far lower than an exhaustive search method.

A RIS comprises a plurality of reflective elements, each of which is independently controlled to apply a particular change (e.g. phase shift) to the incident wireless signal. It is generally desirable to increase the number of reflective elements of a RIS as it enables greater control of the beam and increased capacity. However, existing methods of RIS beam training have beam training times that are proportional to the number of reflective elements. It is generally desirable to reduce the beam training time as user data is not transmitted during beam training and the process must be repeated when the communication channel between the RIS and user has changed.

### SUMMARY OF THE INVENTION

According to a first aspect of the invention, there is provided a network node for configuring a Reconfigurable Intelligent Surface, RIS, in a wireless telecommunications network, the wireless telecommunications network comprising a transmitting node and a receiving node, the network node comprising a configuration module configured to: configure the RIS according to a beam training codebook so as to define a training beam pair; obtain data indicative of a direction between the RIS and the receiving node, the direction between the RIS and receiving node derivable from the powers of each beam of the training beam pair at the receiving node; and configure the RIS according to a data transmission codebook, the data transmission codebook defining a data transmission beam in the direction between the RIS and the receiving node.

According to a second aspect of the invention, there is provided a method of configuring a Reconfigurable Intelligent Surface, RIS, in a wireless telecommunications network, the wireless telecommunications network comprising a transmitting node and a receiving node, the method comprising the steps of: configuring the RIS according to a beam training codebook so as to define a training beam pair; obtaining data indicative of a direction between the RIS and the receiving node, the direction between the RIS and receiving node derivable from the powers of each beam of the training beam pair at the receiving node; and configuring the RIS according to a data transmission codebook, the data transmission codebook defining a data transmission beam in the direction between the RIS and the receiving node.

The obtained data may indicate a power of each training beam of the training beam pair at the receiving node, and the method may further comprise the step of determining the direction between the RIS and the receiving node based on the powers of each beam of the training beam pair.

The beam training codebook may define a plurality of training beam pairs and the obtained data may indicate the power of each beam of each training beam pair of the plurality of training beam pairs, and the method may further comprise the steps of (or the configuration module may be further configured to): identifying a training beam pair of the plurality of training beam pairs having the greatest power at the receiving node, wherein determining the direction between the RIS and the receiving node may be based on the powers of each beam of the identified training beam pair.

The plurality of training beam pairs may comprise a first set in which each training beam pair satisfies Bμ/f_{c}>β in which B is the bandwidth used in communications between the transmitter and receiver, μ is a direction of the training beam pair from the RIS to the receiver, f_{c} is the central frequency of the training beam pair, and β is a beam split threshold configured such that the training beam pair has negligible beam split.

The plurality of training beam pairs may comprise a second set in which each training beam pair satisfies Bμ/f_{c}≤β in which B is the bandwidth used in communications between the transmitter and receiver, μ is a direction of the training beam pair from the RIS to the receiver, f_{c} is the central frequency of the training beam pair, and β is a beam split threshold configured such that the training beam pair has non-negligible beam split.

Each training beam pair of the second set of the plurality of training beam pairs may be defined as [μ̅−δ, μ̅+δ] in which μ̅ is the direction of the training beam from the RIS and δ is the width of the training beam pair defined as μ̅B/2f_{c}.

Each training beam pair of the second set of the plurality of training beam pairs may be defined as [μ̅−κδ, μ̅+κδ], in which κ is a range restriction parameter. κ may be in a range from 0.7 to 0.9.

According to a third aspect of the invention, there is provided a receiving node in a wireless telecommunications network, the wireless telecommunications network comprising a transmitting node and a Reconfigurable Intelligent Surface, RIS, the receiving node comprising: a receiver configured to receive a training beam pair transmitted by the transmitting node and reflected by the RIS; a measurement module configured to determine the power of each training beam of the training beam pair at the receiving node; and a processor configured to determine a direction between the RIS and the receiving node based on the powers of each beam of the training beam pair at the receiving node.

According to a fourth aspect of the invention, there is provided a method of operating a receiving node in a wireless telecommunications network, the wireless telecommunications network comprising a transmitting node and a Reconfigurable Intelligent Surface, RIS, the method comprising the steps of: receiving a training beam pair transmitted by the transmitting node and reflected by the RIS; determine a power of each training beam of the training beam pair at the receiving node; and determining a direction between the RIS and the receiving node based on the powers of each beam of the training beam pair at the receiving node.

Receiving a training beam pair may include receiving a plurality of training beam pairs, and determining a power of each training beam of the training beam pair may include determining a power of each training beam of each training beam pair of the plurality of training beam pairs, and the method further comprises the steps of (or the processor may be further configured to): identifying a training beam pair of the plurality of training beam pairs having the greatest power at the receiving node, wherein determining the direction between the RIS and the receiving node may be based on the powers of each beam of the identified training beam pair.

The method may further comprise the step of (or the configuration module or processor may be further configured to): normalise the power of each training beam of each training beam pair of the plurality of training beam pairs, wherein identifying the training beam pair of the plurality of training beam pairs having the greatest power at the receiver is based on the normalised power.

The direction between the RIS and UE may be determined as:

$$\hat{ϕ} = \overline{μ} - arcsin ( \frac{χ sin ( π δ ) - χ \sqrt{1 - {χ}^{2}} sin ( π δ ) cos ( πδ )}{{sin}^{2} ( π δ ) + {χ}^{2} {cos}^{2} ( π δ )} )$$

in which χ is defined as:

$$χ = \frac{{{g}_{I} ( ϕ )}^{2} - {{g}_{II} ( ϕ )}^{2}}{{{g}_{I} ( ϕ )}^{2} + {{g}_{II} ( ϕ )}^{2}}$$

in which g_{I}(φ)² is the power of a first training beam of the training beam pair at the receiver, g_{II}(φ)² is the power of a second training beam of the training beam pair at the receiver, and δ is the width of the training beam pair defined as μ̅B/2f_{c}.

The method may further comprise the step of (or the processor may be further configured to): send a message including the determined direction between the RIS and the receiving node so as to cause the RIS to use a data transmission codebook defining a data transmission beam in the determined direction between the RIS and the receiving node.

According to a fifth aspect of the invention, there is provided a computer program comprising instructions which, when the program is executed by a computer, cause the computer to carry out the steps of either the second or fourth aspect of the invention. The computer program may be provided on a computer readable carrier medium.

### BRIEF DESCRIPTION OF THE FIGURES

In order that the present invention may be better understood, embodiments thereof will now be described, by way of example only, with reference to the accompanying drawings in which:

FIG. 1 is a schematic diagram of a wireless telecommunications system of a first embodiment of the present invention, including a base station, Reconfigurable Intelligent Surface (RIS) and User Equipment (UE);

FIG. 2 is a flow diagram illustrating steps implemented by the base station of FIG. 1 as part of a communication configuration method of the first embodiment of the present invention;

FIG. 3 is a flow diagram illustrating steps implemented by the UE of FIG. 1 as part of the communication configuration method of the first embodiment of the present invention;

FIG. 4 is a flow diagram illustrating a step of generating a plurality of parameters of the communication configuration method of FIG. 2 in more detail;

FIG. 5 is a flow diagram illustrating a step of estimating a direction between the RIS and UE of the communication configuration method of FIG. 2 in more detail;

FIG. 6 is a schematic diagram illustrating the received power of a wide-beam-pair at a first wide beam and a second wide beam:

FIG. 7 is a schematic diagram illustrating a design of the wide-beam-pair and a corresponding beam training range;

FIG. 8 is a graph illustrating a simulation of the achievable rate performance against Signal to Noise Ratio, SNR, for the communication configuration method of FIG. 2 and a plurality of conventional techniques, in which the number of reflective elements equals 1024;

FIG. 9 is a graph illustrating a simulation of the achievable rate performance against SNR for the communication configuration method of FIG. 2 and a plurality of conventional techniques, in which the number of reflective elements equals 2048;

FIG. 10 is a graph illustrating a simulation of the achievable rate performance against beam training overhead for the communication configuration method of FIG. 2 and a plurality of conventional techniques, in which the number of reflective elements equals 1024; and

FIG. 11 is a graph illustrating a simulation of the achievable rate performance against beam training overhead for the communication configuration method of FIG. 2 and a plurality of conventional techniques, in which the number of reflective elements equals 2048.

### DETAILED DESCRIPTION OF EMBODIMENTS

Notation: Lower-case and upper-case boldface letters represent vectors and matrices, respectively; (⋅)^{T}, (⋅)^{H} denote the transpose and conjugate transpose, respectively; ∥⋅∥ₖ denotes the k-norm of a matrix; |⋅| denotes the absolute operator; v[i] denotes the i-th element in a vector, v; M[:,i] denotes the i-th column in a matrix, M; CN(μ,Σ) denotes the Gaussian distribution with mean μ and covariance Σ; and υ(a, b) denotes the uniform distribution between a and b.

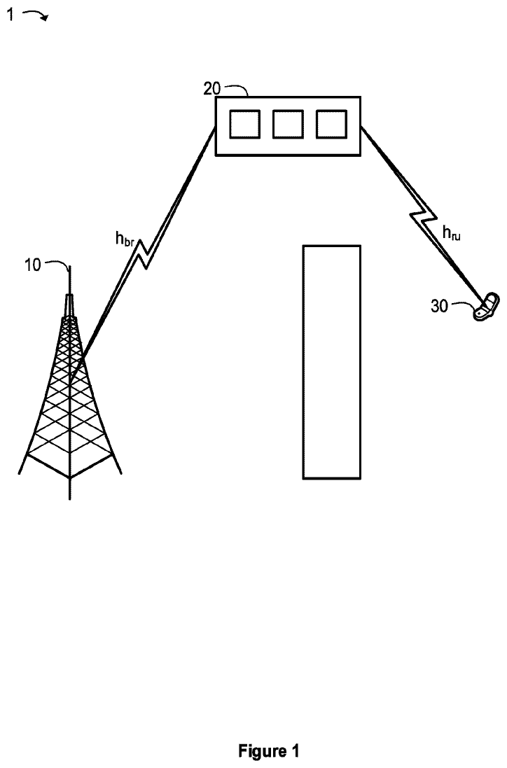

A first embodiment of a wireless telecommunications system will now be described with reference to FIG. 1. In this embodiment, the wireless telecommunications system is a cellular telecommunications network 1 having a base station 10, a Reconfigurable Intelligent Surface (RIS) 20, and a User Equipment (UE) 30. The base station 10 utilises a single antenna, the RIS 20 has a Uniform Linear Array (ULA) configuration comprising N reflective elements, and the UE 30 utilises a single antenna. The base station 10 uses Orthogonal Frequency Division Multiplexing (OFDM) with M subcarriers to serve the UE. The bandwidth of the system is denoted as B.

As shown in FIG. 1, a communications path between the base station 10 and the UE 30 includes a first channel between the base station 10 and the RIS 20, h_{br}, and a second channel between the RIS 20 and UE 30, hᵣᵤ. In this example, the direct channel between the base station 10 and UE 30 is blocked and is not considered in the following analysis. Considering a ray-based channel model for wideband TeraHertz (THz) channel (as described in “BDMA for millimeter-wave/terahertz massive MIMO transmission with per-beam synchronization,” IEEE J. Sel. Areas Commun., vol. 35, no. 7, pp. 1550-1563, July 2017, L. You et al.), the downlink channel for the m-th subcarrier between the base station 10 and the RIS 20, h_{br,m}ϵ [symbol] , with m=1, 2, . . . , M is denoted as:

$${h}_{br , m} = {\sum }_{{l}_{1} = 1}^{{L}_{1}} {g}_{br , m}^{( {l}_{1} )} {e}^{- j {πτ}_{br , m}^{( {l}_{1} )} {f}_{m}} {a}_{N} ( {φ}_{m}^{( {l}_{1}} ) \qquad ( 1 )$$

In which:

$${g}_{br , m}^{( {l}_{1} )}$$

denotes the path gain of the l₁-th path for l₁=1, 2, . . . , L₁;

$${τ}_{br , m}^{( {l}_{1} )}$$

denotes the time delay of the l₁-th path for l₁=1, 2, . . . , L₁;
fₘ denotes the frequency of the m-th subcarrier which satisfies

$${f}_{m} = {f}_{c} + \frac{B}{M} ( m - 1 - \frac{M - 1}{2} )$$

with f_{c} being the central frequency of the system;
L₁ denotes the number of paths;
j is the imaginary unit (which satisfies j²=−1); and
a_{N}ϵ [symbol] denotes the array response vector which satisfies:

$${a}_{N} ( {φ}_{m}^{( {l}_{1} )} ) = {\frac{1}{\sqrt{N}} [ 1 , {e}^{j {πφ}_{m}^{( {l}_{1} )}} , {e}^{2 j {πφ}_{m}^{( {l}_{1} )}} , … , {e}^{( N - 1 ) j {πφ}_{m}^{( {l}_{1} )}} ]}^{T} \qquad ( 2 )$$

In which:

$${φ}_{m}^{( {l}_{1} )}$$

denotes the spatial angle of the l₁-th path, which satisfies

$${φ}_{m}^{( {l}_{1} )} = \frac{2 d}{c} {f}_{m} sin ( {γ}^{( {l}_{1} )} )$$

for l₁=1, 2, . . . , L₁ with γ^{(l}^{₁}⁾ being the physical angle of the l₁-th path;
d is the antenna spacing;
c is the speed of light; and
λ_{c} is the wavelength of the central frequency

$$( note d = \frac{{λ}_{c}}{2} = \frac{c}{2 {f}_{c}} ) .$$

Similar to the definition of h_{br,m} above, the downlink channel for the m-th subcarrier between the RIS 20 and the UE 30, h_{ru,m}ϵ [symbol] with m=1, 2, . . . , M is denoted as:

$${h}_{ru , m} = {\sum }_{{l}_{2} = 1}^{{L}_{2}} {g}_{r u , m}^{( {l}_{2} )} {e}^{- j π {τ}_{r u , m}^{( {l}_{2} )} {f}_{m}} {a}_{N} ( {ψ}_{m}^{( {l}_{2} )} ) \qquad ( 3 )$$

In which:

$${g}_{ru , m}^{( {l}_{2} )}$$

denotes the path gain of the l₂-th path for l₂=1, 2, . . . , L₂;

$${τ}_{ru , m}^{( {l}_{2} )}$$

denotes the time delay of the l₂-th path for l₂=1, 2, . . . , L₂;
L₂ denotes the number of paths;

$${ψ}_{m}^{( {l}_{2} )}$$

denotes the spatial angle of the l₂-th path; and
a_{N} denotes the array response vector which also satisfies equation (2).

At the RIS 20, each reflective element re-scatters the incident signal with a particular amount of phase shift (as described in “Reconfigurable intelligent surfaces: Principles and opportunities,” IEEE Commun. Surv. Tutorials, vol. 23, no. 3, pp. 1546-1577, July 2021, Y. Liu et al.). With θₙ denoting the phase shift of the n-th reflective element of the RIS 20 and βₙ denoting the amplitude reflection coefficient of the n-th reflective element of the RIS 20, the reflecting matrix, Θ, of the RIS 20 is represented as:

$$Θ {=}^{Δ} diag ( {β}_{1} {e}^{j {θ}_{1}} , {β}_{2} {e}^{j {θ}_{2}} , … , {β}_{N} {e}^{j {θ}_{N}} ) \qquad ( 4 )$$

In which θₙ ϵ[0, 2π) and βₙ ϵ[0,1] for all n=1, 2, . . . , N. Equation (4) indicates that the reflective elements of the RIS 20 are frequency-independent. For simplicity, it is assumed the phase can be shifted consecutively and βₙ=1 for all nϵ{1, 2, . . . , N}.

Based on the channel model and the reflecting matrix discussed above, the received signal yₘ at the m-th subcarrier at the UE 30 can be represented as:

$${y}_{m} = {h}_{ru , m}^{H} Θ {h}_{br , m} s + n \qquad ( 5 )$$

In which:
s denotes the transmitted signal at the base station 10,
n is the Additive White Gaussian Noise (AWGN) vector which satisfies n~CN(0, σ²I_{K}), where σ² represents the noise power.

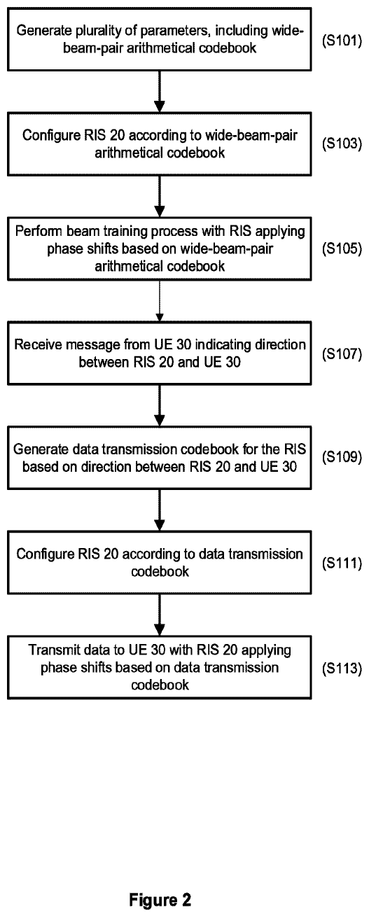

A method of configuring communications in the cellular telecommunications network 1 of FIG. 1 will now be described with reference to FIGS. 2 to 5. FIG. 2 is a flow diagram illustrating steps implemented by the base station 10 as part of an overall communication configuration method of this first embodiment. This communication configuration method is based on wide-beam-pair arithmetical beam training.

In a first step, S101, the base station 10 generates a plurality of parameters including a vector representing a central direction of each beam pair, μ, a vector representing a power normalisation coefficient, ç, and a wide-beam-pair arithmetical codebook, W for the RIS 20. The process for generating each of these parameters is described in detail below.

In step S103, the base station 10 sends a first message to the RIS 20 so as to configure the RIS 20 according to the wide-beam-pair arithmetical codebook, W, and sends a second message to the UE 30 including the vector representing a power normalisation coefficient, ç (this second message may be sent via a pre-existing channel between the base station 10 and UE 30, via the RIS 20, which may have been configured in a previous implementation of this first embodiment).

In step S105, the base station 10 performs a beam training process during a plurality of time slots designated for beam training. Specifically, the base station 10 transmits training signals in which each training signal is transmitted in an i-th time slot of the plurality of time slots. The RIS 20 applies phase shifts to each training signal according to Θ=diag(W[:, i]), as configured in step S103.

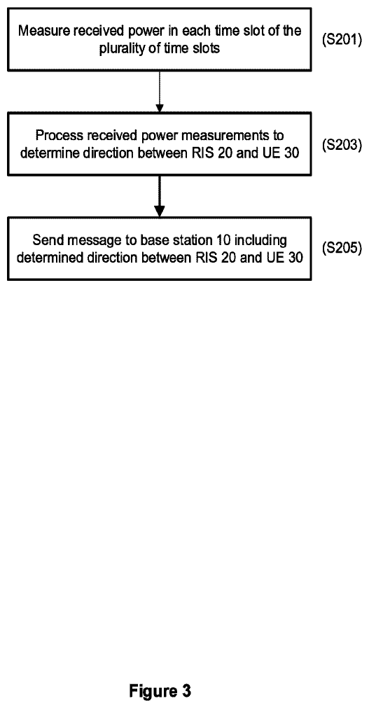

Turning to FIG. 3, which illustrates steps implemented by the UE 30 as part of the overall communication configuration method of this first embodiment, in step S201, the UE 30 measures the received power in each time slot, p[i], until the plurality of time slots designated for beam training is complete. In step S203, the UE 30 processes the measured received power in each time slot, p[i], to determine the direction between the RIS 20 and UE 30, \hat{φ}. This direction determination step is also discussed in more detail below. In step S205, the UE 30 sends a message to the base station 10 including the determined direction between the RIS 20 and UE 30, \hat{φ}.

Turning back to FIG. 2, in step S107, the base station 10 receives the message indicating the direction between the RIS 20 and UE 30, \hat{φ}. In step S109, the base station 10 generates a data transmission codebook for the RIS 20. This data transmission codebook for the RIS 20 is generated such that the RIS 20 produces a beam in the direction between the RIS 20 and UE 30, \hat{φ}, as received in step S107. Generation of the data transmission codebook, as per step S109, is described in more detail below.

In step S111, the base station 10 configures the RIS 20 according to the data transmission codebook. In step S113, the base station 10 transmits data to the UE 30 via the RIS 20, in which the RIS 20 applies phase shifts according to the data transmission codebook.

Steps S101 to S113 may be repeated at a later time to reconfigure the base station 10 and RIS 20 for communications with the UE 30 according to the conditions at that time (if, for example, the UE 30 is in a new position).

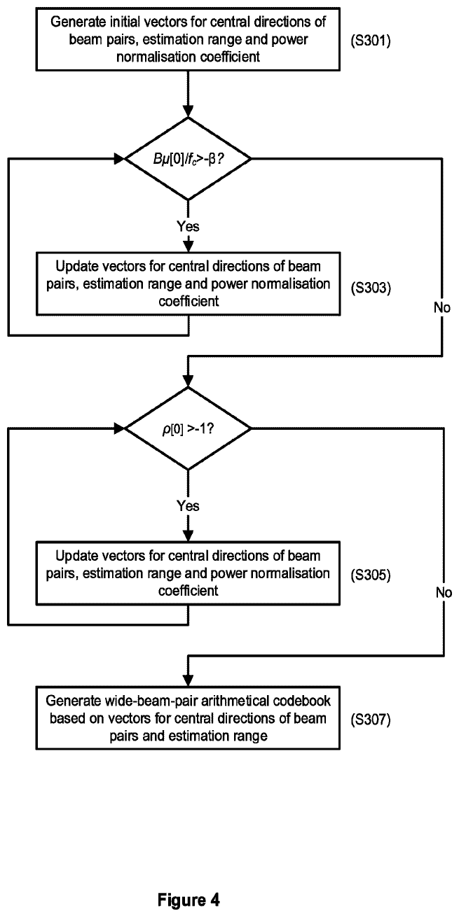

The step S101 of generating a plurality of parameters will now be described with reference to FIG. 4. This process utilises input parameters that are known to the base station 10 and may be configured and updated by an operator, including the number of reflective elements in the RIS, N, the bandwidth, B, the central frequency, f_{c}, a range parameter, κ, and a dividing parameter, β. The range parameter, κ, has a value in range from 0 and 1, and in this embodiment has value 0.8. A suitable value for the range parameter may be determined by simulation. When the range parameter is relatively high (e.g. >0.9), the beam training accuracy will decrease at the end of the estimation range, but the beam training overhead will reduce accordingly. When the range parameter is relatively low (e.g. <0.7) the beam training accuracy will improve but the beam training overhead will be higher. Simulations by the present inventors indicate that a range parameter in the range of 0.7 to 0.9 performs well.

The dividing parameter is an operator defined threshold such that a first plurality of parameters is generated for directions in which beam split is negligible and a second plurality of parameters are generated for directions in which beam split is non-negligible. In this embodiment, the dividing parameter, β, is 1/N.

In step S301, the base station 10 generates an initial vector for the central directions of the beam pairs,

$$μ = [ \frac{1}{N} , \frac{1}{N} ] ,$$

an initial vector for the estimation range,

$$ρ = [ - \frac{1}{N} , \frac{1}{N} ] ,$$

and an initial vector for the power normalisation coefficient,

$$ς = [ \frac{2}{N} , \frac{2}{N} ] .$$

In step S303, the base station 10 enters a first loop in which the vectors for the central directions of the beam pairs, μ, estimation range, ρ, and power normalisation coefficient, ç, are all updated according to the following logic:

$$while B μ [ 0 ] / {f}_{c} > - β do$$

$$μ = [ μ [ 0 ] - \frac{2}{N} , μ , - μ [ 0 ] + \frac{2}{N} ] ;$$

$$ρ = [ ρ [ 0 ] - \frac{2}{N} , ρ , - ρ [ 0 ] + \frac{2}{N} ] ;$$

$$σ = [ \frac{2}{N} , ς , \frac{2}{N} ] ;$$

$$end while$$

On notation, the number in square brackets indicates the position in the vector (such that, for the first iteration of the first loop following initialisation of μ as

$$[ - \frac{1}{N} , \frac{1}{N} ] , μ [ 0 ]$$

$$- \frac{1}{N} ) .$$

Furthermore, each vector is updated to include the previous version of the vector

$$( i . e . {μ}_{updated} = [ {μ}_{previous} [ 0 ] - \frac{2}{N} , {μ}_{previous} , - {μ}_{previous} [ 0 ] + \frac{2}{N} ] ) .$$

This first loop generates a plurality of parameters to define conventional narrow beams for directions between the RIS 20 and the UE 30 when the beam split effect can be neglected. The difference in the central direction of each beam pair is 2/N. The direction of the narrow beam is equivalent to the estimation range, so ρ is equal to μ and the power normalisation is equal to the width of the narrow beam.

Once the base station 10 has completed the first loop, the base station 10 enters (in step S305) a second loop in which the vectors for the central directions of the beam pairs, μ, estimation range, ρ, and power normalisation coefficient, ç, are all updated according to the following logic:

$$while ρ [ 0 ] > - 1 do$$

$$\overline{μ} - \frac{2 ρ [ 0 ] {f}_{c}}{2 {f}_{c} - κ B} ;$$

$$δ = \frac{B}{2 {f}_{c}} \overline{μ} ;$$

$$μ = [ - \overline{μ} , μ ; \overline{μ} ] ;$$

$$ρ = [ - \overline{μ} - κδ , ρ , \overline{μ} + κδ ] ;$$

$$ς = [ \frac{B \overline{μ}}{{f}_{c}} , ς , \frac{B \overline{μ}}{{f}_{c}} ] ;$$

$$end while$$

This second loop generates a plurality of parameters to define wide beams for directions between the RIS 20 and UE 30 where the beam split effect is non-negligible. This second loop is discussed in more detail below.

Based on the previous estimation range μ̅+κδ, the central direction of the next wide-beam-pair should satisfy:

$${\overline{μ}}_{n e w} - κ \frac{B}{2 {f}_{c}} {\overline{μ}}_{n e w} = {\overline{μ}}_{old} + κ \frac{B}{2 {f}_{c}} {\overline{μ}}_{old} = - ρ [ 0 ] , \qquad ( 6 )$$

$$⇒ {\overline{μ}}_{n e w} = \frac{2 ρ [ 0 ] {f}_{c}}{2 {f}_{c} - κ B}$$

The array gain of each wide beam is different because the total transmission power is fixed but the width of each wide beam varies. Therefore, the power normalisation coefficient for each wide beam is generated whose value is in proportion to the beam width.

Once the base station 10 has completed the second loop, the vectors for the central directions of the beam pairs, μ, estimation range, ρ, and power normalisation coefficient, ç, have been generated. In step S307, the base station 10 generates the wide-beam-pair arithmetical codebook, W, based on equation (12) below.

An example of steps S301 to S307 will now be described. In this example, the number of reflective elements of the RIS 20, N, is 100, the bandwidth, B, is 1e10, the central frequency, f_{c}, is 1e11, the range parameter, κ, is 0.8 and the dividing parameter, β, is 0.01. In step S301, the base station 10 generates initial vectors for the central directions of the beam pairs,

$$μ = [ \frac{- 1}{100} , \frac{1}{100} ] ,$$

for the estimation range,

$$ρ = [ \frac{- 1}{100} , \frac{1}{100} ] ,$$

and the power normalisation coefficient,

$$ϛ = [ \frac{2}{100} , \frac{2}{100} ] = [ \frac{1}{50} , \frac{1}{50} ] .$$

In step S303, the base station 10 determines that

$$B μ [ 0 ] / {f}_{c} = \frac{1 e 10 * \frac{- 1}{1100}}{1 e 11} = \frac{- 1}{1000}$$

is greater than −0.01 so the base station 10 enters a first iteration of the first loop:

$$μ = [ μ [ 0 ] - \frac{2}{N} , μ , - μ [ 0 ] + \frac{2}{N} ] = [ \frac{- 1}{100} - \frac{2}{100} , \frac{- 1}{100} , \frac{1}{100} , - \frac{- 1}{100} + \frac{2}{100} ] = [ \frac{- 3}{100} , \frac{- 1}{100} , \frac{1}{100} , \frac{3}{100} ] ;$$

$$ρ = [ ρ [ 0 ] - \frac{2}{N} , ρ , - ρ [ 0 ] + \frac{2}{N} ] = [ \frac{- 1}{100} - \frac{2}{100} \frac{- 1}{100} ′ \frac{1}{100} , - \frac{- 1}{100} + \frac{2}{100} ] = [ \frac{- 3}{100} \frac{- 1}{100} \frac{1}{100} . \frac{3}{100} ]$$

$$ϛ = [ \frac{2}{N} , ϛ , \frac{2}{N} ] = [ \frac{2}{100} , \frac{1}{50} , \frac{1}{50} , \frac{2}{100} ] = [ \frac{1}{50} , \frac{1}{50} , \frac{1}{50} , \frac{1}{50} ] ;$$

Following this first iteration, the base station 10 determines, for the value of μ[0] following the first iteration of the first loop, that

$$B μ [ 0 ] / {f}_{c} = \frac{1 e 10 * \frac{- 3}{1100}}{1 e 11} = \frac{- 3}{1000}$$

is greater than −0.01 so the base station 10 enters a second iteration of the first loop:

$$μ = [ μ [ 0 ] - \frac{2}{N} , μ , - μ [ 0 ] + \frac{2}{N} ] = [ \frac{- 3}{100} - \frac{2}{100} , \frac{- 3}{100} , \frac{- 1}{100} , \frac{1}{100} , \frac{3}{100} , - \frac{- 3}{100} + \frac{2}{100} ] = [ \frac{- 5}{100} , \frac{- 3}{100} , \frac{- 1}{100} , \frac{1}{100} , \frac{3}{100} , \frac{5}{100} ] ;$$

$$ρ = [ ρ [ 0 ] - \frac{2}{N} , ρ , - ρ [ 0 ] + \frac{2}{N} ] = [ \frac{- 3}{100} - \frac{2}{100} , \frac{- 3}{100} , \frac{- 1}{100} , \frac{1}{100} , \frac{3}{100} , - \frac{- 3}{100} + \frac{2}{100} ] = [ \frac{- 5}{100} , \frac{- 3}{100} , \frac{- 1}{100} , \frac{1}{100} , \frac{3}{100} , \frac{5}{100} ] ;$$

$$ϛ = [ \frac{2}{N} , ϛ , \frac{2}{N} ] = [ \frac{2}{100} , \frac{1}{50} , \frac{1}{50} , \frac{1}{50} , \frac{1}{50} , \frac{2}{100} ] = [ \frac{1}{50} , \frac{1}{50} , \frac{1}{50} , \frac{1}{50} , \frac{1}{50} , \frac{1}{50} ] ;$$

This iterative process continues until the condition Bμ[0]/f_{c}>−β is no longer satisfied. Once complete, the base station 10 has determined the following values for the vectors for the central directions of the beam pairs, μ, the estimation range, ρ, and the power normalisation coefficient, ç:

$$μ = [ \frac{- 11}{100} , \frac{- 9}{100} , \frac{- 7}{100} , \frac{- 5}{100} , \frac{- 3}{100} , \frac{- 1}{100} , \frac{1}{100} , \frac{3}{100} , \frac{5}{100} , \frac{7}{100} , \frac{9}{100} , \frac{11}{100} ] ;$$

$$ρ = [ \frac{- 11}{100} , \frac{- 9}{100} , \frac{- 7}{100} , \frac{- 5}{100} , \frac{- 3}{100} , \frac{- 1}{100} , \frac{1}{100} , \frac{3}{100} , \frac{5}{100} , \frac{7}{100} , \frac{9}{100} , \frac{11}{100} ] ;$$

$$ϛ = [ \frac{1}{50} , \frac{1}{50} , \frac{1}{50} , \frac{1}{50} , \frac{1}{50} , \frac{1}{50} , \frac{1}{50} , \frac{1}{50} , \frac{1}{50} , \frac{1}{50} , \frac{1}{50} , \frac{1}{50} ] ;$$

In step S305, the base station 10 determines that

$$ρ [ 0 ] = \frac{- 11}{100}$$

is greater than −1 so the base station 10 enters a first iteration of the second loop:

$$\overline{μ} = - \frac{2 ρ [ 0 ] {f}_{c}}{2 {f}_{c} - κ B} = - \frac{2 * \frac{- 11}{100} * 1 e 11}{2 * 1 e 11 - 0.8 * 1 e 10} = 0.1146 ;$$

$$δ = \frac{B}{2 {f}_{c}} \overline{μ} = \frac{1 e 10}{2 * 1 e 11} * 0.1146 = 0 \text{.00573} ;$$

$$μ = [ - \overline{μ} , μ , \overline{μ} ] = [ - 0.1146 , \frac{- 11}{100} , \frac{- 9}{100} , \frac{- 7}{100} , \frac{- 5}{100} , \frac{- 3}{100} , \frac{- 1}{100} , \frac{1}{100} , \frac{3}{100} , \frac{5}{100} , \frac{7}{100} , \frac{9}{100} , \frac{11}{100} , 0.11 \; 46 ] ;$$

$$ρ = [ - \overline{μ} - κ δ , ρ , \overline{μ} + κδ ] = [ - 0. 1192 , \frac{- 11}{100} , \frac{- 9}{100} , \frac{- 7}{100} , \frac{- 5}{100} , \frac{- 3}{100} , \frac{- 1}{100} , \frac{1}{100} , \frac{3}{100} , \frac{5}{100} , \frac{7}{100} , \frac{9}{100} , \frac{11}{100} , 0.1192 ]$$

$$ς = [ \frac{B \overline{μ}}{{f}_{c}} , ς , \frac{B \overline{μ}}{{f}_{c}} ] = [ 0. 1146 , \frac{1}{50} , \frac{1}{50} , \frac{1}{50} , \frac{1}{50} , \frac{1}{50} , \frac{1}{50} , \frac{1}{50} , \frac{1}{50} , \frac{1}{50} , \frac{1}{50} , \frac{1}{50} , \frac{1}{50} , 0.01146 ]$$

Following this first iteration of the second loop, the base station 10 determines, for the value of ρ[0] following this first iteration of the second loop, whether ρ[0] is greater than −1. If so, the base station 10 enters a second iteration of the second loop. If not, then the process ends and the vectors for the central directions of the beam pairs, μ, the estimation range, ρ, and the power normalisation coefficient, ç are complete. The wide-beam-pair arithmetical codebook, W, is then generated according to equation (12).

Returning to FIG. 2, following completion of step S101, the base station 10 has generated the vector for the central directions of the beam pairs, μ, the vector for the estimation range, ρ, the vector for the power normalisation coefficient, ç, and the wide-beam-pair arithmetical codebook, W. In step S103, the base station 10 configures the RIS 20 according to the wide-beam-pair arithmetical codebook, W and communicates the vector for the power normalisation coefficient, ç, to the UE 30.

In step S105, the base station 10 transmits training signals in which each training signal is transmitted in an i-th time slot of the plurality of time slots with the RIS 20 configured according to Θ=diag(W[:,i]). In other words, in a first time slot (i=0), the RIS 20 is configured to apply a phase shift in the first time slot to create a beam pair defined as

$$μ [ 0 ] - \frac{B}{2 {f}_{c}} μ [ 0 ] and μ [ 0 ] + \frac{B}{2 {f}_{c}} μ [ 0 ] ( having width \frac{B}{2 {f}_{c}} μ [ 0 ] ) ,$$

in which μ[0] is the first element of the vector μ following the final iteration of step S305, apply a phase shift in the second time slot (i=1) to create a beam pair defined as

$$μ [ 1 ] - \frac{B}{2 {f}_{c}} μ [ 1 ] and μ [ 1 ] + \frac{B}{2 {f}_{c}} μ [ 1 ] ( having width \frac{B}{2 {f}_{c}} μ [ 1 ] ) ,$$

in which μ[1] is the second element of the vector μ following the final iteration of step S305, etc.

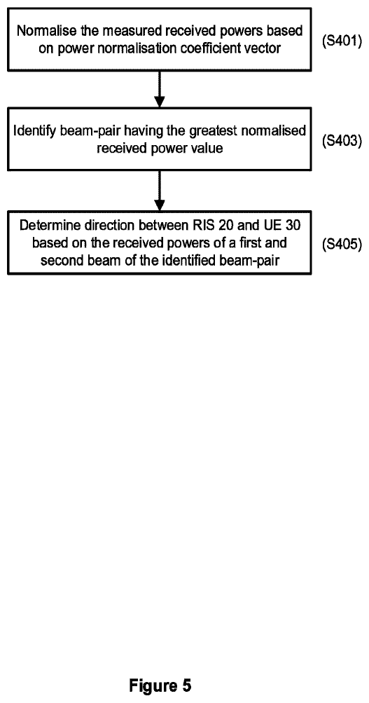

Turning to FIG. 3, in step S201, the UE 30 measures the received power in each time slot, p[i], until the plurality of time slots designated for beam training is complete. In step S203, the UE 30 processes the received power measurements to determine the direction between the RIS 20 and UE 30, \hat{φ}. This will now be described in more detail with reference to FIG. 5.

In step S401, the UE 30 normalises the measured received powers in each time slot based on the vector for the power normalisation coefficient, ç:

$$\tilde{ρ} = ρ ⊙ ϛ \qquad ( 6 )$$

The measured received power is therefore multiplied by the power normalisation coefficient, ç, for the corresponding time slot. In other words, the measured received power in time slot 0 is multiplied by ç[0], the measured received power in time slot 1 is multiplied by ç[1], etc.

In step S403, the UE 30 identifies the beam-pair, j, having the greatest normalised received power value (more specifically, the beam-pair having the greatest average normalised received power for each beam of the beam pair):

$$j = {arg max}_{i} \tilde{ρ} [ i ] \qquad ( 7 )$$

The identified beam-pair, j, may be one of the beam-pairs generated in the first loop of step S303 or one of the beam-pairs generated in the second loop of step S305.

In step S405, the UE 30 determines the direction between the RIS 20 and UE 30, 4, as:

$$\hat{ϕ} = \overline{μ} - arcsin ( \frac{χsin ) ( π δ ) - χ \sqrt{1 - {χ}^{2}} sin ( π δ 〉 cos ( πδ )}{{sin}^{2} ( π δ ) + {χ}^{2} {cos}^{2} ( π δ )} ) \qquad ( 8 )$$

In which χ is defined as:

$$χ = \frac{{{g}_{I} ( ϕ )}^{2} - {{g}_{II} ( ϕ )}^{2}}{{{g}_{I} ( ϕ )}^{2} + {{g}_{II} ( ϕ )}^{2}} \qquad ( 9 )$$

In which g_{I}(φ)² is the normalised received power of a first beam of the identified beam-pair, j, and g_{II}(φ)² is the normalised received power of a second beam of the identified beam-pair, j.

Returning to FIG. 3, following completion of step S203, the UE 30 has determined the direction between the RIS 20 and UE 30, \hat{φ}. This direction is communicated by the UE 30 (step S205) and received at the base station 10 (in step S107).

Returning to FIG. 2, in step S109, the base station 10 generates a data transmission codebook for the RIS 20 such that, once configured according to this data transmission codebook, the RIS 20 produces a beam in the direction between the RIS 20 and UE 30, \hat{φ}. This beam is generated based on equations (9) to (13) below in which term μ_{c} in equation (11) is substituted with \hat{φ}, and the beam width ω̅ in equations (9) and (10) is set as

$$\frac{B}{{f}_{c}} \hat{ϕ} .$$

This method is discussed in more detail in paper: “3-D Beamforming for Flexible Coverage in Millimeter-Wave UAV Communications,” L. Zhu et al., IEEE Wireless Communications Letters, vol. 8, no. 3, pp. 837-840, June 2019.

In step S111, the base station 10 configures the RIS 20 according to the data transmission codebook (e.g. by sending a configuration message to the RIS 20). In step S113, the base station 10 transmits data to the UE 30 via the RIS 20, in which the RIS 20 applies phase shifts according to the data transmission codebook.

A derivation of the equation for determining φ is set out below.

This method follows a concept outlined in “3-D beamforming for flexible coverage in millimeter-wave UAV communications,” IEEE Wireless Commun. Lett., vol. 8, no. 3, pp. 837-840, June 2019, L. Zhu et al., in which the RIS 20 is divided into a plurality of sub-arrays, each of which apply a traditional beamforming method. By configuring the direction of each beam of the plurality of sub-arrays a wide beam with a predetermined width is created as a combination of the beams of the plurality of sub-arrays. Specifically, the RIS 20 is divided into K sub-arrays which satisfies:

$$\frac{2}{N s} \times K \geq \overline{ω} \qquad ( 9 )$$

In which:
N_{S} is a count of reflective elements in each sub-array of the plurality of sub-arrays; and
ω̅ is the intended width of the wide beam.

Since K and N_{S} are both integers then KN_{S}≤N, which means

$$K = ⌊ \frac{N}{{N}_{s}} ⌋ \geq \frac{N}{{N}_{s}} - 1 .$$

So, by substituting K with

$$\frac{N}{{N}_{s}} - 1 ,$$

we get a sufficient condition for equation (9):

$${N}_{s} \leq \frac{\sqrt{1 + 2 N ϖ} - 1}{π} \qquad ( 10 )$$

N_{S} needs to be sufficiently high to achieve sufficient array gain to compensate for path loss. N_{S} may therefore be determined as the maximum integer that satisfies equation (9). K may then be determined as

$$K = ⌊ \frac{N}{{N}_{s}} ⌋ .$$

Once K and N_{S} have been determined, the directions of the beam for each sub-array of the plurality of sub-arrays are determined. With a central direction of a wide beam generated as the combination of all beams of the plurality of sub-arrays being μ_{c}, and the width of the beam of the particular sub-array of the plurality of sub-arrays being 2/N_{S}, the direction of the beam of a particular sub-array is:

$${υ}_{k} = {μ}_{c} + \frac{2 k - K - 1}{{N}_{s}} , k = 1 , 2 , … , K \qquad ( 11 )$$

The reflecting matrix of the RIS 20 can therefore be written as:

$$Θ [ i ( k , n ) , i ( k , n ) ] = \frac{1}{\sqrt{N}} {e}^{j π [ ( k - 1 ) {N}_{s} + n - 1 ] {υ}_{k}} {e}^{j {ϵ}_{k}} , \qquad ( 12 )$$

$$k = 1 , 2 , … , K + 1 , n = 1 , 2 , … , {N}_{s}$$

In which:
i(k, n)=(k−1)N_{S}+n denotes the index of the RIS 20 units, and ϵₖ is the phase compensation so as to maintain a consistent phase for each subcarrier, which satisfies ϵₖ=kΔε, in which ΔE is defined as:

$$Δϵ = \{ \begin{matrix}\frac{( {N}_{s} - 1 ) π}{{N}_{s}} + π & {N}_{s}^{4} {sin}^{2} ( \frac{π}{2 {N}_{s}} ) \geq 8 \\ 2 arccos ( \frac{\sqrt{2}}{4} {N}_{2}^{2} sin \frac{π}{2 {N}_{s}} ) & {N}_{s}^{4} {sin}^{2} ( \frac{π}{2 {N}_{s}} ) < 8\end{matrix} . \qquad ( 13 )$$

The derivation of ϵₖ is shown in Appendix A below.

As noted above, the wide-beam-pair arithmetical codebook, W, is generated based on equation (12). Values for N_{S}, νₖ, ϵₖ can be obtained by equations (9), (10) and (12). Specifically, μ_{c} in equation (10) is set as μ[i]-μ[i]×B/f_{c} and μ[i]+μ[i]×B/f_{c} for the beam pair. The beam width ω̅ is set as μ[i]×B/f_{c} for both beams.

For a targeted UE at φ and a wide beam steered to μ_{c} with width 2δ (both in spatial domain), and the subcarrier frequencies ranging from f₁ to f_{M}, the directions of beams at each subcarrier range from

$$\frac{μ}{{ξ}_{M}} to \frac{μ}{{ξ}_{1}} ,$$

where ξₘ=fₘ/f_{c}. As a result, UE 30 can satisfactorily receive the mₚ-th subcarrier when mₚ satisfies

$${m}_{p} ∈ {ℳ}_{p} = \{ m \vert \frac{μ}{{ξ}_{i}} - δ \leq ϕ \leq \frac{μ}{{ξ}_{m}} + δ , m ∈ ℳ \} , \qquad ( 14 )$$

$$ℳ = \{ 1 , 2 , … , M \} ,$$

In contrast, the UE 30 cannot satisfactorily receive the mₙ-th subcarrier when mₙ satisfies:

$${m}_{n} ∈ {ℳ}_{n} = \{ m \vert ϕ < \frac{μ}{{ξ}_{m}} - δ ‖ ϕ > \frac{μ}{{ξ}_{m}} + δ , m ∈ ℳ \} , \qquad ( 15 )$$

$$ℳ = \{ 1 , 2 , … , M \} ,$$

Therefore, while μ changes, the received power at the UE 30 changes. This property is exploited so as to improve the accuracy and reduce the overhead of beam training in wideband communications systems, such as wideband THz communication systems.

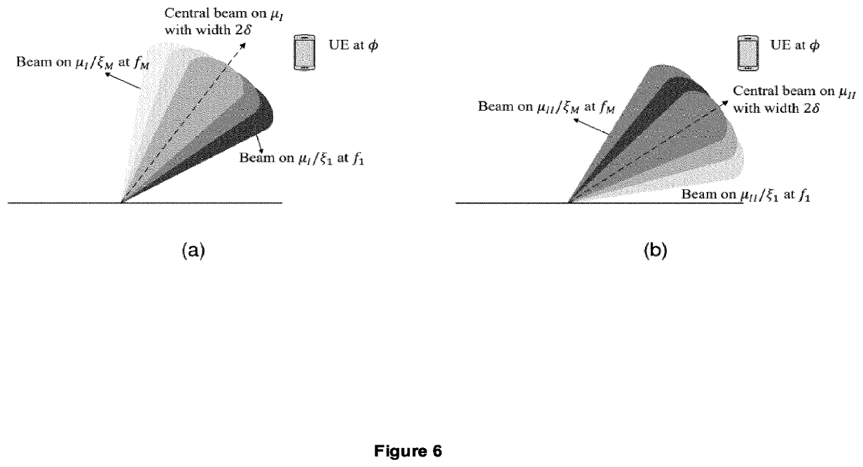

FIG. 6 illustrates (a) a first wide beam (wide beam I) and (b) a second wide beam (wide beam II). For wide beam I, subcarriers indexed by m_{n,I}ϵ [symbol] _{p,I}={m|\tilde{m}≤m≤M} can transmit signals satisfactorily, while subcarriers indexed by m_{n,I}ϵ [symbol] _{n,I}={m|1≤m≤\tilde{m}} cannot transmit signals satisfactorily. For wide beam II, subcarriers indexed by m_{n,II}ϵ [symbol] _{n,II}={m|1≤m≤\tilde{m}} can transmit signals satisfactorily, while subcarriers indexed by m_{p,II}ϵ [symbol] _{p,II}={m|\tilde{m}≤m≤M} cannot transmit signals satisfactorily. This phenomenon results in the difference in received power corresponding to the two wide beams at the UE 30. By designing the directions and the widths of the beam pair appropriately (as described below), the received powers at the UE 30 can be used to calculate the physical direction of the UE 30.

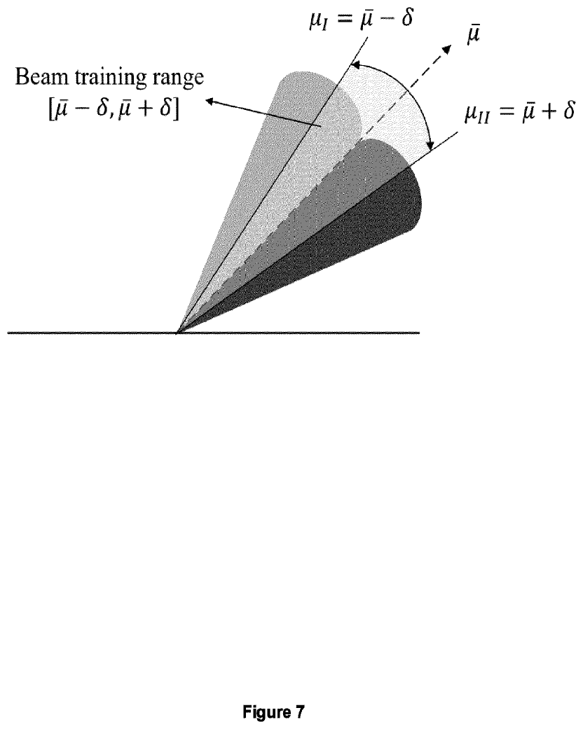

FIG. 7 illustrates a wide-beam-pair and its corresponding beam training range. The central direction of the wide beam pair is denoted as μ̅. Since the estimation of the direction is based on the received power, the beam width of each beam pair should be the same so that their respective array gains are the same. As noted above, the directions of beams at each subcarrier range from

$$\frac{μ}{{ξ}_{M}} to \frac{μ}{{ξ}_{1}} .$$

We therefore set the width of the beam pair as ω̅=2δ=μ̅(f_{c}/f₁−f_{c}/f_{M})≈μ̅B/f_{c}. In order to fully utilise the channel information carried by each subcarrier, the difference of the central direction of the two wide beams of the wide-beam-pair should equal the beam width. Therefore, μ_{I}=μ̅−δ and μ_{II}=μ̅+δ. With this configuration, when UE 30 is positioned in the range [μ̅−δ, μ̅+δ], it is able to receive the signals of both wide beams and the received power can be utilised to calculate the physical direction between the RIS 20 and UE 30.

For a UE at φϵ[μ̅−δ, μ̅+δ], the received power of the first wide beam can be presented as:

$${{\vert {g}_{I} ( ϕ ) \vert}^{2} = \vert {\sum }_{n = 1}^{M} [ {a}_{N}^{H} ( {ϕ}_{m} ) Θ ( {μ}_{I} ) ] \vert}^{2} \approx 𝒞 \frac{{sin}^{2} ( \frac{π {N}_{a} ( ϕ - \overline{μ} + δ )}{2} )}{{sin}^{2} ( \frac{π ( ϕ - \overline{μ} + δ )}{2} )} , \qquad ( 16 )$$

In which [symbol] is a constant unrelated to φ and μ_{I}. The derivation of equation (16) is shown in Appendix B.

Similarly, for the same UE at φϵ[μ̅−δ, μ̅+δ], the received power of the second wide beam can be presented as:

$${\vert {g}_{II} ( ϕ ) \vert}^{2} \approx 𝒞 \frac{{sin}^{2} ( \frac{π {N}_{s} ( ϕ - \overline{μ} - δ )}{2} )}{{sin}^{2} ( \frac{π ( ϕ - \overline{μ} - δ )}{2} )} , \qquad ( 17 )$$

In which [symbol] is a constant unrelated to φ and μ_{I}. Since δ≈K/N_{S}, according to equation (9), the numerators of equations (16) and (17) are equal. The difference in the received power of the first wide beam at the UE 30 and the received power of the second wide beam at the UE 30 is therefore based on the denominators.

Based on the received power of the wide-beam-pair, the arithmetical direction estimation method is proposed as follows. To estimate the direction, an appropriate metric must be selected. Considering the random noise and unknown distance between the RIS 20 and UE 30, the value of the received power itself is not useful. Only the relative difference (of the received power of the first wide beam and the received power of the second wide beam) eliminates the uncertain factors in the system and carriers the actual information of the channel. A ratio metric, χ, is introduced, which was presented earlier in this description as equation (9) and repeated here:

$$χ = \frac{{{g}_{I} ( ϕ )}^{2} - {{g}_{II} ( ϕ )}^{2}}{{{g}_{I} ( ϕ )}^{2} + {{g}_{II} ( ϕ )}^{2}} \qquad ( 9 )$$

By applying equations (16) and (17), X can be represented as:

$$χ = \frac{{sin}^{2} ( \frac{π ( ϕ - \overline{μ} - δ )}{2} ) - {sin}^{2} ( \frac{π ( ϕ - \overline{μ} + δ )}{2} )}{{sin}^{2} ( \frac{π ( ϕ - \overline{μ} - δ )}{2} ) + {sin}^{2} ( \frac{π ( ϕ - \overline{μ} - δ )}{2} )} = - \frac{sin ( π ( ϕ - \overline{μ} ) ) sin ( πδ )}{1 - cos ( π ( ϕ - \overline{μ} ) ) cos ( πδ )} , \qquad ( 18 )$$

In which φ−μ̅ϵ[−δ, δ]. The direction between the RIS 20 and UE 30, φ, can then be estimated (as \hat{φ}) using equation (8) presented earlier in this description and repeated here:

$$\hat{ϕ} = \overline{μ} - arcsin ( \frac{χsin ( πδ ) - χ \sqrt{1 - {χ}^{2}} sin ( πδ ) cos ( πδ )}{{sin}^{2} ( π δ ) + {χ}^{2} {cos}^{2} ( πδ )} ) \qquad ( 8 )$$

As noted above, in step S305, the vectors for the central directions of the beam pairs, μ_{c}, estimation range, ρ, and power normalisation coefficient, ç, are generated in directions where the beam split effect is non-negligible. It is theoretically possible to define an estimation range for these wide beam pairs in the range [μ̅−δ, μ̅+δ]. However, the gradient near the boundary of this range is approximately zero, which means that a small error in χ results in a large error in \hat{φ}. In practical communication systems, there exists various kinds of noise such that the error in χ is inevitable. The second loop of step S305 therefore introduces a range parameter, κ<1, to limit the estimation range in [μ̅−κδ, μ̅+κδ] to improve the estimation accuracy.

Compared to prior art methods of beam training which rely on the UE merely choosing the beam with the greatest received power, this new arithmetical direction estimation method enables the direction between the RIS 20 and UE 30 to be calculated by making use of the information that is carried in the frequency domain and exploiting the beam split effect which is normally seen as a problem in wideband communication systems. This new arithmetical direction estimation method improves the accuracy of beam training since the beam split effect is considered during derivation. Furthermore, the overhead of the proposed method decreases (relative to traditional exhaustive search methods) since the width of the wide-beam-pair is much wider than traditional narrow beams, meaning fewer beams are required to explore a particular space.

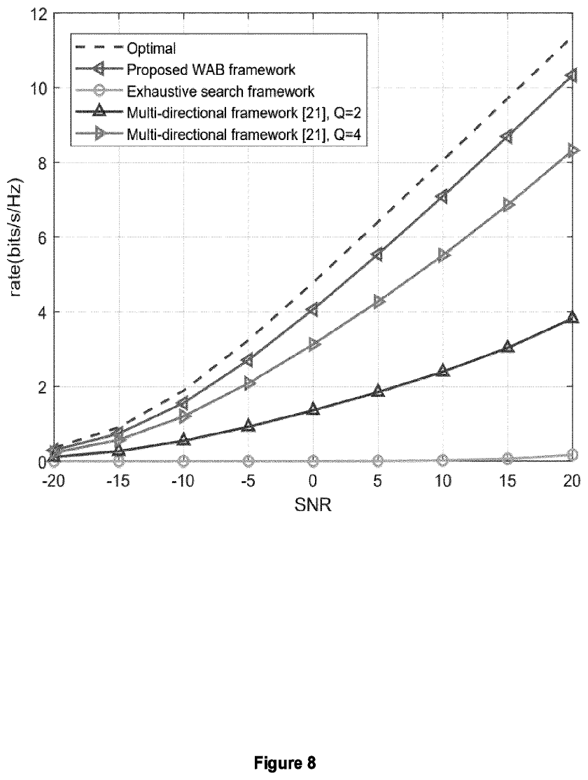

Simulation results for the arithmetical direction estimation method are set out below with reference to FIGS. 8 to 11. In a first simulation, the parameters of the RIS-assisted wideband THz communication system are set as N_{BS}=1, N_{RIS}=1024, N_{UE}=1, f_{c}=100 GHz, B=10 GHz, and the number of subcarriers is set to 128. The THz channel is considered quasi-optical and the number of paths, L, is set to 1. The direction between the RIS 20 and UE 30 is set to satisfy φ~ [symbol] (−π/3,π/3).

FIG. 8 illustrates the achievable rate performance of the beam training method of the first embodiment of the present invention compared to the multi-directional beam training framework discussed in the Background section above and traditional exhaustive beam training framework. The training overhead (that is, the number of transmitted beams) is set to 128 in this example. The parameter Q in the multi-directional beam training framework represents the number of beams sent at each slot. It can be observed from FIG. 8 that the beam training method of the first embodiment of the present invention outperforms the other methods and it can achieve near-optimal achievable rate performance compared to the optimal situation in which the direction of the UE 30 is known perfectly by the BS 10 and RIS 20. In addition, the traditional exhaustive search cannot work with such a low beam training overhead.

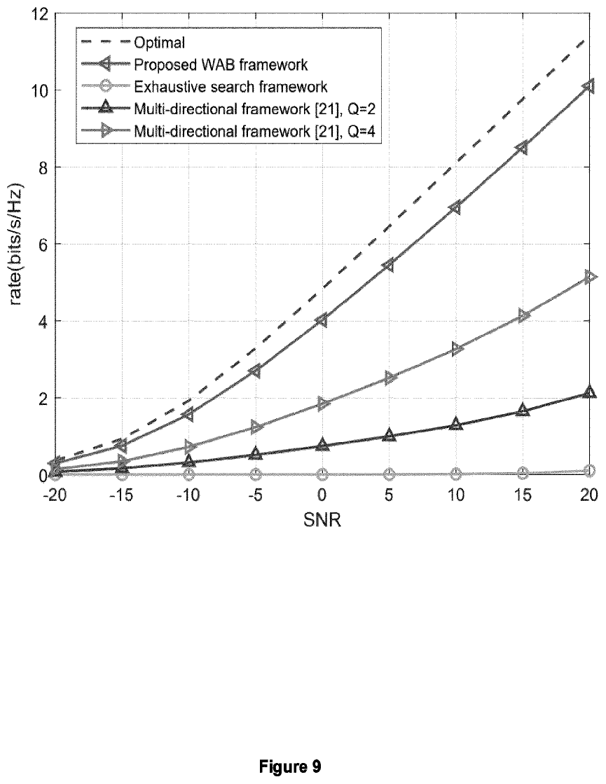

To illustrate the advantage of the beam training overhead of the beam training method of the first embodiment of the present invention not increasing as the number of reflective elements of the RIS 20 increases, a further simulation is shown in FIG. 9 in which the number of reflective elements of the RIS 20, N_{RIS}, is set to 2048. It can be observed that the multi-directional beam training framework suffers from further performance degradation due to the increase in reflective elements, but the achievable rate performance of the beam training method of the first embodiment of the present invention remains the same since the overhead of this beam training method is related merely to the inherent parameters of the wideband communication system (i.e. it is not related to the number of reflective elements). Therefore, this beam training method is highly adaptive to future communication systems with relatively large numbers of reflective elements.

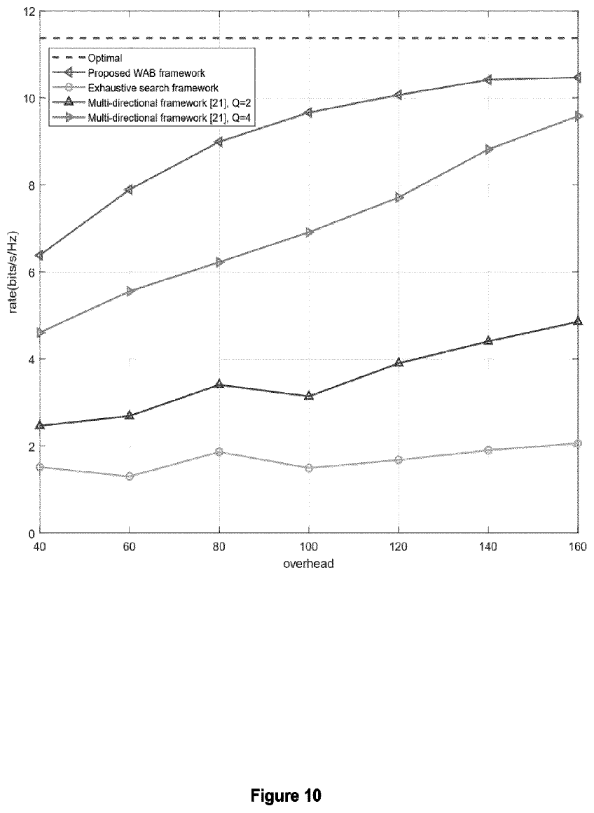

To illustrate the beam training overhead of each beam training framework, FIG. 10 illustrates a simulation of the rate performance of different frameworks as the beam training overhead increases. The SNR is set to 5 dB in this simulation. The horizontal axis represents the beam training overhead. It can be observed from FIG. 10 that the beam training method of the first embodiment achieves near-optimal achievable rate performance with sufficient overhead and outperforms the existing frameworks. In addition, when the training overhead is limited, the achievable rate performance is far better than existing frameworks. This is because the beam training method of the first embodiment reduces the training overhead to a large extent when the UE is far from 0° since the beam split effect is severe. By scanning the space from 90°/−90° to 0°, a large proportion of directions can be estimated accurately with a very low training overhead. It can also be observed from FIG. 10 that the traditional exhaustive search framework barely works when the number of reflective elements is very large.

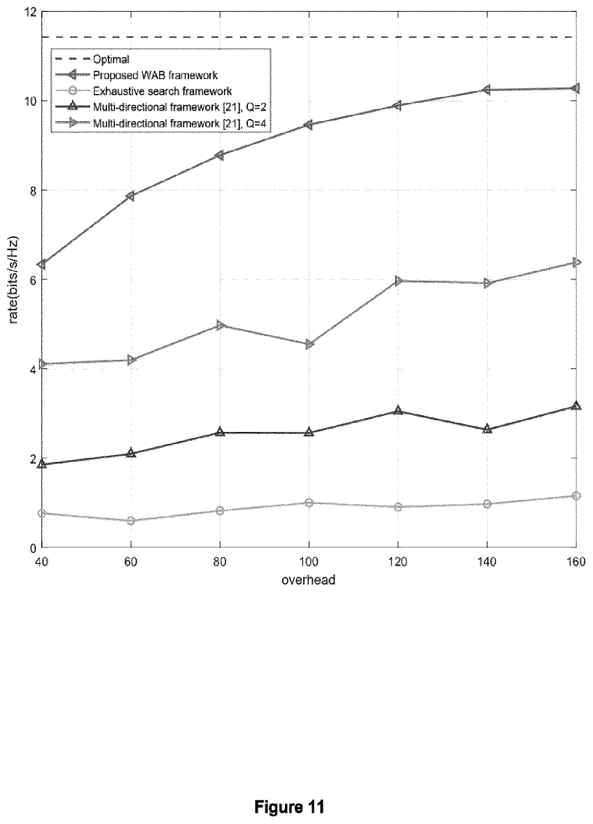

The comparison of the achievable rate performance against the beam training overhead is also simulated with the number of reflective elements, N_{RIS}, set to 2048—as shown in FIG. 11. By comparing FIGS. 10 and 11, it can be observed that the beam training overhead of the beam training method of the first embodiment is unrelated to the number of reflective elements as the achievable rate performance of the beam training method remains the same as N_{RIS}=1024. It can also be observed that the multi-directional framework and exhaustive search framework suffer from a severe performance degradation. The beam training method of the first embodiment therefore has great potential in future wideband communication systems.

In conclusion, these simulations illustrate that the beam training method of the first embodiment reaches the near-optimal achievable rate performance, has a low training overhead, and may adapt to future communication systems with a relatively large number of reflective elements.

In the above first embodiment, the base station 10 and UE 30 cooperate to calculate the codebooks for the RIS 20 and the base station 10 configures the RIS 20 to use the codebooks by sending configuration messages. However, the skilled person will understand that any other network node (or network nodes) may calculate (alone or in cooperation) the codebooks and communicate the calculated codebooks to the RIS 20. Furthermore, the RIS 20 may determine the codebooks, provided it has sufficient processing capacity.

Furthermore, the skilled person will understand that it is non-essential for the RIS to be a ULA and may take any other form.

The skilled person will understand that any combination of features is possible within the scope of the invention, as claimed.

### Appendix A—Derivation of the Phase Compensation in Equation (12)

The array gain of the k-th sub-array at v can be presented as:

$${{{\vert g ( k ) \vert}^{2} = {\vert {a}_{N}^{H} ( \overline{ν} ) Θ ( {ν}_{k} ) \vert}^{2} = \vert {\sum }_{p = 1}^{K + 1} {\sum }_{n = 1}^{N} \frac{1}{N} {e}^{- j π [ ( p - 1 ) {N}_{a} + n - 1 ] \overline{ν}} {e}^{j π \vert ( p - 1 ) {N}_{s} + n - 1 ] {ν}_{k}} {e}^{j {ϵ}_{p}} \vert}^{2} = \frac{1}{{N}^{2}} {\vert {\sum }_{p = 1}^{K + 1} {e}^{- j π ( p - 1 ) ( 2 p - 2 k - 1 )} {e}^{j {ϵ}_{p}} {\sum }_{n = 1}^{N} {e}^{j π ( n - 1 ) \frac{2 p - 2 k - 1}{{N}_{s}}} \vert}^{2} {\approx }^{( a )} \frac{1}{{N}^{2}} {\vert {e}^{j π ( k - 1 )} {e}^{j {ϵ}_{k}} {\sum }_{n = 1}^{{N}_{s}} e \frac{- j π ( n - 1 )}{{N}_{s}} + {e}^{- j π k} {e}^{j {ϵ}_{k + 1}} {\sum }_{n = 1}^{{N}_{s}} {e}^{\frac{j π ( n - 1 )}{{N}_{s}}} \vert}^{2} = \frac{1}{{N}^{2}} \vert {\sum }_{n = 1}^{{N}_{s}} {e}^{\frac{- j π ( n - 1 )}{N}} - {e}^{j ( {ϵ}_{k + 1} - {ϵ}_{k} )} {\sum }_{n = 1}^{{N}_{s}} {e}^{\frac{j π ( n - 1 )}{{N}_{s}}} \vert}^{2} = \frac{1}{{N}^{2}} \frac{1}{{N}_{s}^{2} {sin}^{2} \frac{π}{2 {N}_{s}}} {\vert {e}^{i \frac{( {N}_{s} - 1 ) π}{2 {N}_{s}}} - {e}^{j ( {ϵ}_{k + 1} - {ϵ}_{k} )} {e}^{- j \frac{( {N}_{s} - 1 ) π}{2 {N}_{s}}} \vert}^{2} , \qquad ( 19 )$$

In which (a) is explained by Lemma 1.

$$Lemma 1.$$

$${\vert {\sum }_{p = 1}^{K + 1} {\sum }_{n = 1}^{{N}_{s}} {e}^{j π ( n - 1 ) \frac{2 p - 2 k - 1}{{N}_{s}}} \vert}^{2} \approx {\vert {\sum }_{n = 1}^{{N}_{s}} {e}^{- j π \frac{n - 1}{{N}_{s}}} + {\sum }_{n = 1}^{{N}_{s}} {e}^{j π \frac{n - 1}{{N}_{s}}} \vert}^{2} . \qquad ( 20 )$$

$$Proof .$$

$${\vert {\sum }_{p = 1}^{K + 1} {\sum }_{n = 1}^{{N}_{s}} {e}^{j π ( n - 1 ) \frac{{2}_{p} - 2 k - 1}{{N}_{s}}} \vert}^{2} = {\vert {\sum }_{p = 1}^{K = 1} {e}^{j π \frac{2 k - 2 p + 1}{{N}_{s}}} \frac{sin \frac{{N}_{s} π}{2} \frac{2 p - 2 k - 1}{{N}_{s}}}{{N}_{s} sin \frac{π}{2} \frac{2 p - 2 k - 1}{{N}_{s}}} {e}^{j \frac{( 3 {N}_{s} - 1 ) π}{2} \frac{2 p - 2 k - 1}{{N}_{s}}} \vert}^{2} . \qquad ( 21 )$$

Considering the value of

$$f ( p ) = {\vert \frac{sin \frac{{N}_{s}}{2} \frac{2 p - 2 k - 1}{{N}_{s}}}{{N}_{s} sin \frac{π}{2} \frac{π 2 p - 2 k - 1}{2 {N}_{s}}} \vert}^{2} , p = 1 , 2 , … , K + 1 ,$$

due to the symmetry of this function, when p=k+½, f(p) reaches its maximum value 1. However, since p is an integer, the actual maximum value of f(p) is reached when p*=k and p*=k+1. If p is not the two maximum points above, then

$$\frac{f ( p )}{f ( {p}^{*} )} \leq \frac{{sin}^{2} π / 2 {N}_{s}}{{sin}^{2} 3 π / 2 {N}_{s}} , \qquad ( 22 )$$

Where Nₛ is relatively large, so we have

$$\frac{f ( p )}{f ( {p}^{*} )} \leq 1 / 9 ,$$

thus these terms can be neglected. By reversing the two maximum points of f(p), the lemma can be proved.

According to equation (19), the total array gain at v can be presented as:

$$𝒫 = {\vert g ( k ) \vert}^{2} + {\vert g ( k + 1 ) \vert}^{2} = 𝒞 ( {\vert {e}^{j \frac{( {N}_{s} - 1 ) π}{2 {N}_{s}}} - {e}^{j ( {ϵ}_{k + 1} - {ϵ}_{k} )} {e}^{- j \frac{( {N}_{s} - 1 ) π}{2 {N}_{s}}} \vert}^{2} + {\vert {e}^{j \frac{( {N}_{s} - 1 ) π}{2 {N}_{s}}} - {e}^{j ( {ϵ}_{k + 2} - {ϵ}_{k + 1} )} {e}^{- j \frac{( {N}_{s} - 1 ) π}{2 {N}_{s}}} \vert}^{2} ) , \qquad ( 23 )$$

In which

$$𝒞 = \frac{1}{{N}^{2} {N}_{s}^{2} {sin}^{2} \frac{π}{2 {n}_{s}}}$$

is a constant unrelated to ϵ. The two terms have the same structure. In order to avoid the serration and guarantee sufficient array gain, [symbol] is set to Nₛ²/N², which is the designed array gain of each sub-array. Thus,

$${\vert {e}^{j \frac{( {N}_{s} - 1 ) π}{2 {N}_{s}}} - {e}^{j ( {ϵ}_{k + 1} - {ϵ}_{k} )} {e}^{- j \frac{( {N}_{s} - 1 ) π}{2 {N}_{s}}} \vert}^{2} = min \{ 4 , \frac{{N}_{s}^{4} {sin}^{2} ( \frac{π}{2 {N}_{s}} )}{2} \} . \qquad ( 24 )$$

For simplicity, only the equation for the first term is derived. The equation for the second term is similar to equation (24) due to the same structure. Therefore, the phase compensation e must satisfy equation (13) set out above and repeated here:

$$Δϵ = \{ \begin{matrix}\frac{( {N}_{s} - 1 ) π}{{N}_{s}} + π & {N}_{s}^{4} {sin}^{2} ( \frac{π}{2 {N}_{s}} ) \geq 8 \\ 2 arccos ( \frac{\sqrt{2}}{4} {N}_{s}^{2} sin \frac{π}{2 {N}_{s}} ) & {N}_{s}^{4} {sin}^{2} ( \frac{π}{2 {N}_{s}} ) < 8\end{matrix} , \qquad ( 13 )$$

Where Δϵ=ϵₖ₊₁−ϵₖ for all k=1, 2, . . . , K. ϵ may be set as ϵₖ=kΔϵ. Thus, the reflecting matrix of the RIS 20 can be obtained by equations (11), (12) and (13).

### Appendix B—Derivation of Equation (16)

$${\vert g ( ϕ ) \vert}^{2} = {\vert {\sum }_{m = 1}^{M} [ {\sum }_{k = 1}^{K = 1} {\sum }_{n = 1}^{{N}_{s}} \frac{1}{\sqrt{N}} {e}^{- j π [ ( k - 1 ) {N}_{s} + n - 1 ] {ϕ}_{m}} \frac{1}{\sqrt{N}} {e}^{j π [ ( k - 1 ) {N}_{s} + n - 1 ) ] {ϕ}_{m} {ν}_{k}} {e}^{j {ϵ}_{k}} ] \vert}^{2} = \frac{1}{{N}^{2}} {\vert {\sum }_{m = 1}^{M} [ {\sum }_{k = 1}^{K = 1} {e}^{- j π ( k - 1 ) {N}_{s} ( {ϕ}_{m} - {ν}_{k} )} {e}^{j {ϵ}_{k}} {\sum }_{n = 1}^{{N}_{s}} {e}^{j π ( n - 1 ) ( {ϕ}_{m} - {ν}_{k} )} ] \vert}^{2} . \qquad ( 25 )$$

According to Lemma 1, the expression can further be approximated as

$${\vert g ( ϕ ) \vert}^{2} \approx \frac{1}{{N}^{2}} {\vert {\sum }_{m = 1}^{M} [ {\underbrace{{e}^{- j π ( {k}_{1} - 1 ) {N}_{s} ( {ϕ}_{m} - {ν}_{{k}_{1}} )} {e}^{j {ϵ}_{{k}_{1}}}}}_{( a )} {\sum }_{n = 1}^{{N}_{s}} {e}^{j π 〈 n - 1 ) ( {ϕ}_{m} - {ν}_{{k}_{1}} )} + {\underbrace{{e}^{- j π ( {k}_{2} - 1 ) {N}_{s} ( {ϕ}_{m} - {ν}_{{k}_{2}} )} {e}^{j {ϵ}_{{k}_{2}}}}}_{( b )} {\sum }_{n = 1}^{{N}_{s}} {e}^{j π ( n - 1 ) ( {ϕ}_{m} - {ν}_{{k}_{2}} )} ] \vert}^{2} , \qquad ( 26 )$$

### Where

$${k}_{1} = ⌊ \frac{( {ϕ}_{m} - \overline{μ} + δ ) {N}_{s} + K + 1}{2} ⌋ , {k}_{2} = ⌊ \frac{( {ϕ}_{m} - \overline{μ} + δ ) {N}_{s} + K + 1}{2} ⌋ .$$

Here, (a) and (b) are the phase compensation, so the two items can be merged. Therefore,

$${\vert g ( ϕ ) \vert}^{2} \approx \frac{1}{{N}^{2}} {\vert {e}^{- j {πϵ}_{1}} {\sum }_{m = 1}^{M} {\sum }_{n = 1}^{{N}_{s}} {e}^{j π ( n - 1 ) ( {ϕ}_{m} - \overline{μ} + δ )} \vert}^{2} = \frac{1}{{N}^{2}} {\vert {\sum }_{m = 1}^{M} \frac{sin ( \frac{{N}_{s} π}{2} ( {ϕ}_{m} - \overline{μ} + δ ) )}{{N}_{s} sin ( \frac{π}{2} ( {ϕ}_{m} - \overline{μ} + δ ) )} {e}^{j \frac{( {N}_{s} - 1 ) π}{2}} ( {ϕ}_{m} - \overline{μ} + δ ) \vert}^{2} \approx 𝒞 \frac{{sin}^{2} ( \frac{π {N}_{s} ( ϕ - \overline{μ} + δ )}{2} )}{{sin}^{2} ( \frac{π ( ϕ - \overline{μ} + δ )}{2} )} . \qquad ( 27 )$$

1. A network node for configuring a Reconfigurable Intelligent Surface, RIS, in a wireless telecommunications network, the wireless telecommunications network comprising a transmitting node and a receiving node, the network node comprising a configuration module configured to:
configure the RIS according to a beam training codebook so as to define a training beam pair, the training beam pair being created by the RIS in the same timeslot and comprising a first training beam having a first direction and a second training beam having a second direction;
obtain data indicative of a direction between the RIS and the receiving node, the direction between the RIS and receiving node derivable from the powers of the first and second training beams of the training beam pair at the receiving node; and
configure the RIS according to a data transmission codebook, the data transmission codebook defining a data transmission beam in the direction between the RIS and the receiving node.

2. A network node as claimed in claim 1, further comprising a transmitter configured to send a first configuration message to the RIS so as to configure the RIS according to the beam training codebook and further configured to send a second configuration message to the RIS so as to configure the RIS according to the data transmission codebook.

3. A network node as claimed in claim 2, embodied in the transmitting node of the wireless telecommunications network.

4. A network node as claimed in claim 1, embodied in the RIS.

5. A network node as claimed in claim 1, wherein the obtained data indicates a power of the first and second training beams of the training beam pair at the receiving node, and the configuration module is further configured to determine the direction between the RIS and the receiving node based on the powers of the first and second training beams of the training beam pair.

6. A receiving node in a wireless telecommunications network, the wireless telecommunications network comprising a transmitting node and a Reconfigurable Intelligent Surface, RIS, the receiving node comprising:
a receiver configured to receive a training beam pair transmitted by the transmitting node and reflected by the RIS, the training beam pair being created by the RIS in the same timeslot and comprising a first training beam having a first direction and a second training beam having a second direction;
a measurement module configured to determine the power of the first and second training beams of the training beam pair at the receiving node; and
a processor configured to determine a direction between the RIS and the receiving node based on the powers of the first and second training beams of the training beam pair at the receiving node.

7. A receiving node as claimed in claim 6, further comprising:
a transmitter configured to send a message including the determined direction between the RIS and the receiving node so as to cause the RIS to use a data transmission codebook defining a data transmission beam in the determined direction between the RIS and the receiving node.

8. A method of configuring a Reconfigurable Intelligent Surface, RIS, in a wireless telecommunications network, the wireless telecommunications network comprising a transmitting node and a receiving node, the method comprising the steps of:
configuring the RIS according to a beam training codebook so as to define a training beam pair, the training beam pair being created by the RIS in the same timeslot and comprising a first training beam having a first direction and a second training beam having a second direction;
obtaining data indicative of a direction between the RIS and the receiving node, the direction between the RIS and receiving node derivable from the powers of the first and second training beams of the training beam pair at the receiving node; and
configuring the RIS according to a data transmission codebook, the data transmission codebook defining a data transmission beam in the direction between the RIS and the receiving node.

9. A method as claimed in claim 8, wherein the obtained data indicates a power of each training beam of the training beam pair at the receiving node, and the method further comprises the step of determining the direction between the RIS and the receiving node based on the powers of the first and second training beams of the training beam pair.

10. A method as claimed in claim 9, wherein the beam training codebook defines a plurality of training beam pairs and the obtained data indicates the power of respective first and second training beams of each training beam pair of the plurality of training beam pairs, and the method further comprises the steps of:
identifying a training beam pair of the plurality of training beam pairs having the greatest power at the receiving node,
wherein the step of determining the direction between the RIS and the receiving node is based on the powers of the respective first and second training beams of the identified training beam pair.

11. A method as claimed in claim 10, wherein the plurality of training beam pairs comprises a first set in which each training beam pair satisfies
$$B μ / {f}_{c} > β$$
in which B is the bandwidth used in communications between the transmitter and receiver, μ is a direction of the training beam pair from the RIS to the receiver, f_{c} is the central frequency of the training beam pair, and β is a beam split threshold configured such that the training beam pair has negligible beam split.

12. A method as claimed in claim 10, wherein the plurality of training beam pairs comprises a second set in which each training beam pair satisfies
$$B μ / {f}_{c} \leq β$$
in which B is the bandwidth used in communications between the transmitter and receiver, μ is a direction of the training beam pair from the RIS to the receiver, f_{c} is the central frequency of the training beam pair, and β is a beam split threshold configured such that the training beam pair has non-negligible beam split.

13. A method as claimed in claim 12, wherein each training beam pair of the second set of the plurality of training beam pairs is defined as [μ̅−δ,μ̅+δ] in which μ̅ is the direction of the training beam from the RIS and δ is the width of the training beam pair defined as μ̅B/2f_{c}.

14. A method as claimed in claim 12, wherein each training beam pair of the second set of the plurality of training beam pairs is defined as [μ̅−κδ,μ̅+κδ], in which κ is a range restriction parameter.

15. A method as claimed in claim 14, in which κ is in a range from 0.7 to 0.9.

16. A method as claimed in claim 10, further comprising the step of:
normalising the power of the first and second training beams of each training beam pair of the plurality of training beam pairs,
wherein the step of identifying the training beam pair of the plurality of training beam pairs having the greatest power at the receiver is based on the normalised power.

17. A method as claimed in claim 9, wherein the step of determining the direction between the RIS and receiving node is determined as:
$$\hat{ϕ} = \overline{μ} - arcsin ( \frac{χsin ( πδ ) - χ \sqrt{1 - {χ}^{2}} sin ( πδ ) cos ( πδ )}{{sin}^{2} ( πδ ) + {χ}^{2} {cos}^{2} ( πδ )} )$$
in which χ is defined as:
$$χ = \frac{{{g}_{I} ( ϕ )}^{2} - {{g}_{II} ( ϕ )}^{2}}{{{g}_{I} ( ϕ )}^{2} + {{g}_{II} ( ϕ )}^{2}}$$
in which g_{I}(φ)² is the power of the first training beam of the training beam pair at the receiver, g_{II}(φ)² is the power of the second training beam of the training beam pair at the receiver, and δ is the width of the training beam pair defined as μ̅B/2f_{c}.

18. A method of operating a receiving node in a wireless telecommunications network, the wireless telecommunications network comprising a transmitting node and a Reconfigurable Intelligent Surface, RIS, the method comprising the steps of:
receiving a training beam pair transmitted by the transmitting node and reflected by the RIS, the training beam pair being created by the RIS in the same timeslot and comprising a first training beam having a first direction and a second training beam having a second direction;
determine a power of the first and second training beams of the training beam pair at the receiving node; and
determining a direction between the RIS and the receiving node based on the powers of the first and second training beams of the training beam pair at the receiving node.

19. A method as claimed in claim 18, wherein the step of receiving a training beam pair includes receiving a plurality of training beam pairs, and the step of determining a power of each training beam of the training beam pair includes determining a power of respective first and second training beams of each training beam pair of the plurality of training beam pairs, and the method further comprises the steps of:
identifying a training beam pair of the plurality of training beam pairs having the greatest power at the receiving node,
wherein the step of determining the direction between the RIS and the receiving node is based on the powers of the respective first and second training beams of the identified training beam pair.

20. A method as claimed in claim 19, further comprising the step of:
normalising the power of the first and second training beams of each training beam pair of the plurality of training beam pairs,
wherein the step of identifying the training beam pair of the plurality of training beam pairs having the greatest power at the receiving node is based on the normalised power.

21. A method as claimed in claim 18, wherein the step of determining the direction between the RIS and receiving node is determined as:
$$\hat{ϕ} = \overline{μ} - arcsin ( \frac{χ sin ( π δ ) - χ \sqrt{1 - {χ}^{2}} sin ( π δ ) cos ( πδ )}{{sin}^{2} ( π δ ) + {χ}^{2} {cos}^{2} ( π δ )} )$$
in which χ is defined as:
$$χ = \frac{{{g}_{I} ( ϕ )}^{2} - {{g}_{II} ( ϕ )}^{2}}{{{g}_{I} ( ϕ )}^{2} + {{g}_{II} ( ϕ )}^{2}}$$
in which g_{I}(φ)² is the power of the first training beam of the training beam pair at the receiver, g_{II}(φ)² is the power of the second training beam of the training beam pair at the receiver, and δ is the width of the training beam pair defined as μ̅B/2f_{c}.

22. A method as claimed in claim 18, further comprising the step of:
sending a message including the determined direction between the RIS and the receiving node so as to cause the RIS to use a data transmission codebook defining a data transmission beam in the determined direction between the RIS and the receiving node.

23. A computer program comprising instructions which, when the program is executed by a computer, cause the computer to carry out the steps of claim 8.

24. A computer readable carrier medium comprising the computer program of claim 23.
